(19) United States
(12) Patent Application Publication
(10) Pub. No.: US 2021/0345188 A1
(43) Pub. Date: Nov. 4, 2021

(54) RADIO ACCESS NETWORK AND METHODS FOR EXPEDITED NETWORK ACCESS

(71) Applicants: SHARP KABUSHIKI KAISHA, Sakai City, Osaka (JP); FG Innovation Company Limited, Tuen Mun (HK)

(72) Inventor: KAMEL M. SHAHEEN, Camas, WA (US)

(21) Appl. No.: 17/279,522

(22) PCT Filed: Sep. 26, 2019
(86) PCT No.: PCT/JP2019/037978

§ 371 Date: Mar. 24, 2021

Related U.S. Application Data
(60) Provisional application No. 62/738,388, filed on Sep. 28, 2018.

(51) Int. Cl. H04W 36/00; H04W 36/28; H04W 36/38

(52) U.S. Cl. CPC H04W 36/0038; H04W 92/12; H04W 36/38; H04W 36/28

(57) ABSTRACT

In a radio access network wherein a protocol stack is split between anchor processor circuitry and distributed processor circuitry. The anchor processor circuitry is configured to perform high layer radio access network node operations for a connection with a wireless terminal. The distributed processor circuitry is configured to perform low layer radio access network node operations for the connection with the wireless terminal and to utilize the context as used by the anchor processor circuitry. The anchor processor circuitry is configured to provide a first endpoint for a tunnel through which the connection is carried over a packet network to the distributed processor circuitry; the distributed processor circuitry is configured to provide a second endpoint for the tunnel. Transceiver circuitry transmits and receives packets comprising the connection over a radio interface with the wireless terminal.

### CROSS REFERENCE

This Nonprovisional application claims the benefit of and priority under 35 U.S.C. § 119 on provisional Application No. 62/738,388 on Sep. 28, 2018, the entire contents of which are hereby incorporated by reference.

### FIELD

The technology relates to wireless communications, and particularly to radio access network architecture and operation.

### BACKGROUND ART

A radio access network typically resides between wireless devices, such as user equipments (UEs), mobile phones, mobile stations, or any other device having wireless termination, and a core network. Example of radio access network types includes the GRAM, GSM radio access network; the GERAN, which includes EDGE packet radio services; UTRAN, the UMTS radio access network; and E-UTRAN, which includes Long-Term Evolution.

A radio access network may comprise one or more access nodes, such as base station nodes, which facilitate wireless communication or otherwise provides an interface between a wireless terminal and a telecommunications system. A non-limiting example of a base station can include, depending on radio access technology type, a Node B (“NB”), an enhanced Node B (“eNB”), a home eNB (“HeNB”), a gNB (for a New Radio [“NR”] technology system), or some other similar terminology.

The 3rd Generation Partnership Project (“3GPP”) is a group that, e.g., develops collaboration agreements such as 3GPP standards that aim to define globally applicable technical specifications and technical reports for wireless communication systems. Various 3GPP documents may describe certain aspects of radio access networks. Overall architecture for a fifth generation system, e.g., the 5G System, also called “NR” or “New Radio”, as well as “NG” or “Next Generation”, is shown in FIG. 1, and is also described in 3GPP TS 38.300. The 5G NR network is comprises of NG RAN (Next Generation Radio Access Network) and 5GC (5G Core Network). As shown, NG-RAN is comprised of gNBs (e.g., 5G Base stations) and ng-eNBs (i.e. LTE base stations). An Xn interface exists between gNB-gNB, between (gNB)-(ng-eNB) and between (ng-eNB)-(ng-eNB). Xn is the network interface between NG-RAN nodes. Xn-U stands for Xn User Plane interface and Xn-C stands for Xn Control Plane interface. ANG interface exists between 5GC and the base stations (i.e. gNB & ng-eNB). A gNB node provides NR user plane and control plane protocol terminations towards the UE, and is connected via the NG interface to the 5GC. The 5G NR (New Radio) gNB is connected to AMF (Access and Mobility Management Function) and UPF (User Plane Function) in 5GC (5G Core Network). The protocol layers are mapped into three units: RRH (Remote Radio Head), DU (Distributed Unit) and CU (Central Unit) as shown in FIG. 2. FIG. 2 also shows the user plane (UP) protocol stack for New Radio and the control plane (CP) protocol stack for New Radio.

In contrast to classical network architecture, Network Functions Virtualizations, abbreviated as NFV, aims to consolidate many network equipment types onto industry standard high volume servers, switches and storage, which could be located in Datacentres, Network Nodes and in the end user premises, as illustrated in FIG. 3. NFV involves the implementation of network functions in software that can run on a range of industry standard server hardware, and that can be moved to, or instantiated in, various locations in the network as required, without the need for installation of new equipment. “Network Functions Virtualizations-Introductory White Paper” (PDF). ETSI. 22 Oct. 2012. Retrieved 20 Jun. 2013. Standard terminology definitions and NVF use cases that act as references for vendors and operators have been published as announced in Mulligan, Ultan “ETSI Publishes First Specifications for Network Functions Virtualizations” Retrieved 5 Dec. 2013. FIG. 3 particularly shows that radio access network nodes are one of the network elements that may be included in a NFV approach.

Currently, 3GPP is working on defining new generation networks that utilized “Network Function Virtualization” or NFV, such as NFV key elements and key requirements for a fifth generation system, e.g., the 5G System, also called “NR” or “New Radio”, as well as “NG” or “Next Generation”. For example, 3GPP TS 38.913 states that RAN architecture shall allow deployments using Network Function Virtualization; 3GPP TS 38.801 states that NR shall allow Centralized Unit (CU) deployment with Network Function virtualization (NFV), and 3GPP TS 38.401 defines a Network Function as “a logical node within a network infrastructure that has well-defined external interfaces and well-defined functional behavior.”

As currently envisioned, Network Function Virtualization (NFV) allows flexibility, such as flexibility in time and location. In other words, Network Function Virtualization (NFV) allows for assignment of network functions (e.g., logical nodes) dynamically to hardware resources:
at the most appropriate places,
of a currently desirable amount,
as and when needed.
   Network Function Virtualization (NFV) allows flexibility in using hardware resources, and results in capacity/pooling gains, compared to static allocation of hardware resources to logical nodes. For example, using Network Function Virtualization (NFV) the same hardware resource can be assigned to several logical nodes at the same time, instead of a single logical node. For a process executed at a node, a certain single process, e.g. an instance of a New Radio Packet Data Convergence Protocol (NR PDCP) entity, can belong to one, and only one, logical RAN node. However, as soon that single instance of the protocol entity is released (e.g., the NR PDCP protocol entity is released), it can be allocated anew to another logical RAN node. Such a pool of RAN UP protocol entities may be realized in a single physical hardware entity, a central UP entity, and may follow key requirements for 5G system for Network Function Virtualization(NFV). For NG-RAN (including all dual- and multi-connectivity scenarios), such a central UP entity would provide UP interface termination points (i.e. NG-U, Xn-U and F1-U), provide resources for instantiating protocol entities (e.g. GTP-U, SDAP, PDCP), and would provide access to these resources via a control interface towards a logical CP node. The control interface would be the E1 interface (CP only) in case of gNB-CU. If the gNB-CU is implemented as a single logical node (i.e. no CP-UP split is deployed), then such interface would be internal to the gNB-CU. A possible depiction of CU-UP function virtualization for 5GS and NG-RAN consisting of gNBs is shown in FIG. 4. FIG. 4 shows a Network Function Virtualization (NFV) scheme for 5G New Radio, wherein a shared central unit/user plane entity, CU-UP, is connected across an E1 interface to plural control plane units, CU-CP_{gNB}.

A virtualization such as the type shown in FIG. 4 may be utilized in both mobility and multi-connectivity scenarios.
For handover and for resumption in a new RAN node: core network internal signalling can be skipped;
For dual- and multi-connectivity, if the (SDAP/) PDCP entity for a DRB is moved between Master and Secondary node:
   For 5GS, only a single NG-U tunnel is necessary, as the split towards 2 SDAP entities can be regarded as a UP node internal matter;
   Signalling towards the CN is not necessary at all (this implies that also CN internal signalling can be skipped);
   Any kind of QoS flow or DRB offload between involved RAN nodes would be completely unnoticed, i.e. neither CP- or UP-related changes on the NG interface configuration would be necessary.
      In order to support the above:

For mobility—
The source node (e.g., CU-CP) needs to inform the target node (e.g., CU-CP) about the possibility of keeping the RAN-CN tunnel and avoid data forwarding. This can be done for example by adding in the handover request message a new optional JE that includes the existing DL TEIDs.
The target node (e.g., CU-CP) needs to inform the source node (e.g., CU-CP) about the NG-U tunnels that have been successfully kept. This. can be done for example by adding in the handover response message a new optional IE that includes the DL TEIDs that have been successfully kept. This is needed for avoiding data forwarding.
If the target node is split into a CU-CP and a CU-UP, then the corresponding information needs to be added also on the E1 interface in the bearer context setup request/response messages.
The target node needs to inform the core network (MME or AMF) that the DL TEIDs have been kept during the handover. This can be done by adding in the path switch request message a new optional IE that informs the AMF on whether the DL TEID tunnel is unchanged. This is needed for avoiding signalling in the core network.

For EN-DC—
The node that initiates the change of “ownership” of the higher layer UP resources would need to provide a reference to the HL UP resource. Best would be to provide the GITP-U TEID (plus IP address) of the S1-U termination at the E-UTRAN. This needs to be provided in the respective X2AP procedures;
This requires certain topology knowledge of the underlying UP resources from the initiating nodes. While this is already assumed on the RAN-CN UP interface (e.g. the MME knows when to change S-GW in case of inter-RAN node mobility), such knowledge can be also assumed within the E-UTRAN as well;
The initiating node can still provide suggestions, for which E-RAB data forwarding is suggested. If the peer node is not able to access the offered UP resources, it would behave as if such central UP entity would not exist.
On E1, signalling is needed to allow provision of the reference to the offered UP resource.

For MR-DC with 5GC—
With a shared, central UP entity, it is possible to hide MR-DC bearer change/DRB & QoS flow mobility(“offload” related activities from the 5GC.
The QoS flow split between the SDAP entities, which is provided by the UPF in the nominal split, would have to be performed by the central UP entity.
As long as the interface towards the 5GC is handled as if single NG-U connectivity per PDU Session is configured, there is no effect on already agreed interface principles. The only thing that would need to be added to standard is a description of stage 2 level of this option.
As shown for EN-DC, even if E1 is not deployed (as, for now, for an ng-eNB), assuming UP resources that are shared among ng-eNBs and gNBs, such approach is certainly standard compliant.
The Split of QoS flows would not only need to be communicated between the SN and the MN (this is already foreseen, in principle), but also via E1, if deployed. However, if we assume that each logical NG-RAN node configures its SDAP entity, the central UP entity would receive such information anyhow. Similar to EN-DC, the NG-U GTP-U TEID and the PDU Session ID can serve as the context reference on Xn and E1 interfaces.
   However, the foregoing introduces layers and layers of signaling which will ultimately add the delay in session establishment, re-establishment, resume, and ON-OFF operations.

What is needed are methods, apparatus, and/or techniques to expedite and/or simplify access to a virtualized radio access network.

### SUMMARY OF INVENTION

In one example, a radio access network comprising: anchor processor circuitry configured to perform high layer radio access network node operations for a connection with a wireless terminal; distributed processor circuitry configured to perform low layer radio access network node operations for the connection with the wireless terminal and to utilize the context as used by the anchor processor circuitry; transceiver circuitry associated with the distributed processor circuitry and configured to transmit and receive packets comprising the connection over a radio interface with the wireless terminal; wherein the anchor processor circuitry is configured to provide a first endpoint for a tunnel through which the connection is carried over a packet network to the distributed processor circuitry, and wherein the distributed processor circuitry is configured to provide a second endpoint for the tunnel.

In one example, a method in a radio access network comprising: using anchor processor circuitry to perform high layer radio access network node operations for a connection with a wireless terminal and to maintain a context for the connection with the wireless terminal; using distributed processor circuitry to perform low layer radio access network node operations for the connection with the wireless terminal and to utilize the context as used by the anchor processor circuitry; transmitting and receiving packets comprising the connection: between the distributed processor circuitry and the wireless terminal over a radio interface with the wireless terminal; and over a packet network through a tunnel having a first endpoint at the anchor processor circuitry and a second endpoint at the distributed processor circuitry.

### BRIEF DESCRIPTION OF DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view of overall architecture for a 5G New Radio system.

FIG. 2 is a diagrammatic view showing gNB interface types for the 5G New Radio system of FIG. 1.

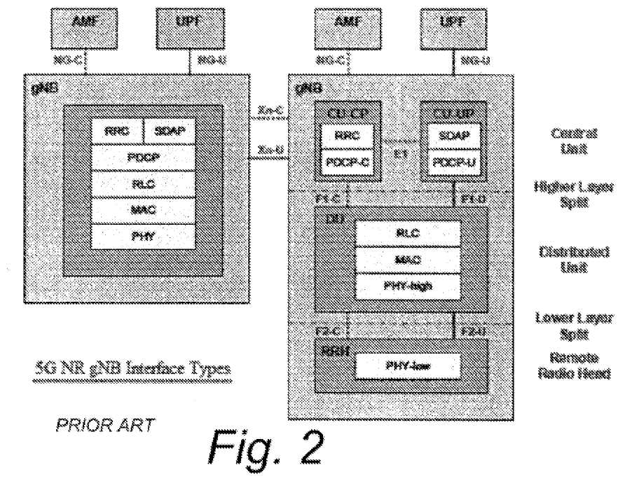

FIG. 3 is a diagrammatic view showing a migration from a classical network appliance approach to a network virtualization approach.

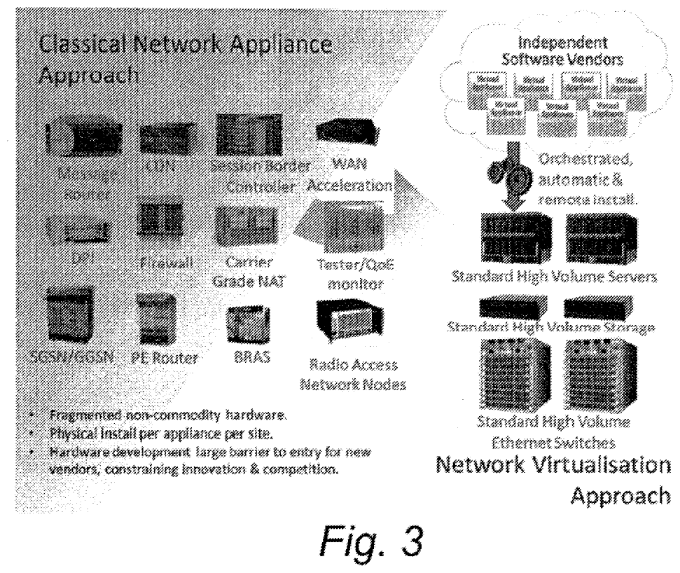

FIG. 4 is a schematic view of an example Network Function Virtualization (NFV) scheme for 5G New Radio.

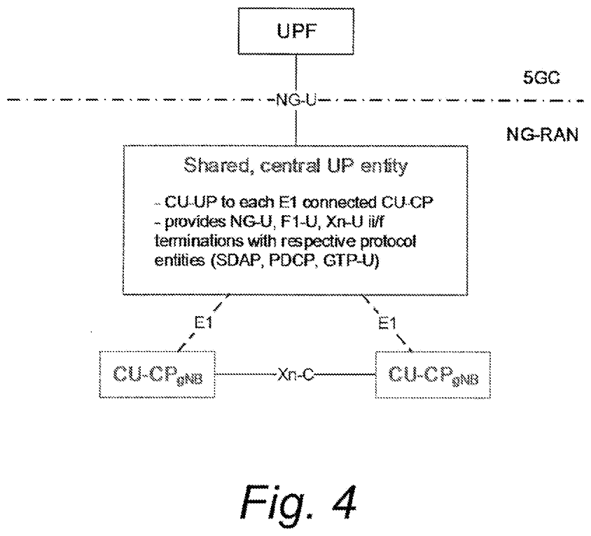

FIG. 5 is a schematic view of an example embodiment of a communications system including a packetized virtual radio access network.

FIG. 6 is a diagrammatic view showing how protocols handled by the radio access network of FIG. 5 are split into high layer protocols and low layer protocols.

FIG. 7 is an enlarged schematic view of distributed processor circuitry of FIG. 5 which additionally shows a MAC controller.

FIG. 8 is a flowchart showing example, basic, representative acts or steps performed by the radio access network of FIG. 5 according to a basic embodiment and mode.

FIG. 9 is a diagrammatic view showing example, representative, basic acts or steps involved in an authentication and registration procedure between a wireless terminal and the radio access network of FIG. 5 according to an example embodiment and mode.

FIG. 10 is a diagrammatic view showing handover of a wireless terminal between various distributed processor circuitry sites of FIG. 5.

FIG. 11 is a flowchart showing example, basic, representative acts or steps performed by the radio access network of FIG. 5 in conjunction with a handover operation.

FIG. 12 is a schematic view of an example embodiment of a communications system including a packetized virtual radio access network and comprising plural anchor processor circuitry servers.

FIG. 13 is a diagrammatic view showing example elements comprising electronic machinery which may comprise a wireless terminal, a radio access node, and a core network node according to an example embodiment and mode.

### DESCRIPTION OF EMBODIMENTS

In one of its example aspects the technology disclosed herein concerns structure and operation of a radio access network wherein a protocol stack is split between anchor processor circuitry and distributed processor circuitry. The anchor processor circuitry is configured to perform high layer radio access network node operations for a connection with a wireless terminal. The distributed processor circuitry is configured to perform low layer radio access network node operations for the connection with the wireless terminal and to utilize the context as used by the anchor processor circuitry. The anchor processor circuitry is configured to provide a first endpoint for a tunnel through which the connection is carried over a packet network to the distributed processor circuitry; the distributed processor circuitry is configured to provide a second endpoint for the tunnel. Transceiver circuitry transmits and receives packets comprising the connection over a radio interface with the wireless terminal.

In an example embodiment and mode, the low layer radio access network node operations comprise a medium access control (MAC) operation. Preferably radio resource management functionality required for the connection is handled by a medium access controller of the distributed processor circuitry. For example, the medium access control (MAC) controller is configured to handle (allocate/modify/release) data radio bearers and signaling radio bearers for the connection. Moreover, in an example embodiment and mode, the medium access control (MAC) controller may be configured to handle negotiate encryption keys for the connection.

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudo code, and the like represent various processes which may be substantially represented in computer readable medium and so executed by a computer or processor, whether or not such computer or processor is explicitly shown.

As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc.

As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc.

As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”), a gNB (for a New Radio [“NR”] technology system), or some other similar terminology.

As used herein, the term “telecommunication system” or “communications system” can refer to any network of devices used to transmit information. A non-limiting example of a telecommunication system is a cellular network or other wireless communication system.

As used herein, the term “cellular network” or “cellular radio access network” can refer to a network distributed over cells, each cell served by at least one fixed-location transceiver, such as a base station. A “cell” may be any communication channel that is specified by standardization or regulatory bodies to be used for International Mobile Telecommunications-Advanced (“IMTAdvanced”). All or a subset of the cell may be adopted by 3GPP as licensed bands (e.g., frequency band) to be used for communication between a base station, such as a Node B, and a UE terminal. A cellular network using licensed frequency bands can include configured cells. Configured cells can include cells of which a UE terminal is aware and in which it is allowed by a base station to transmit or receive information. Examples of cellular radio access networks include E-UTRAN, and any successors thereof (e.g., NUTRAN).

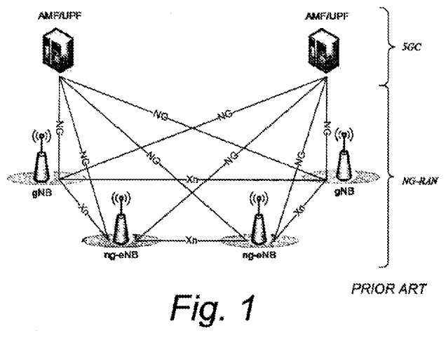

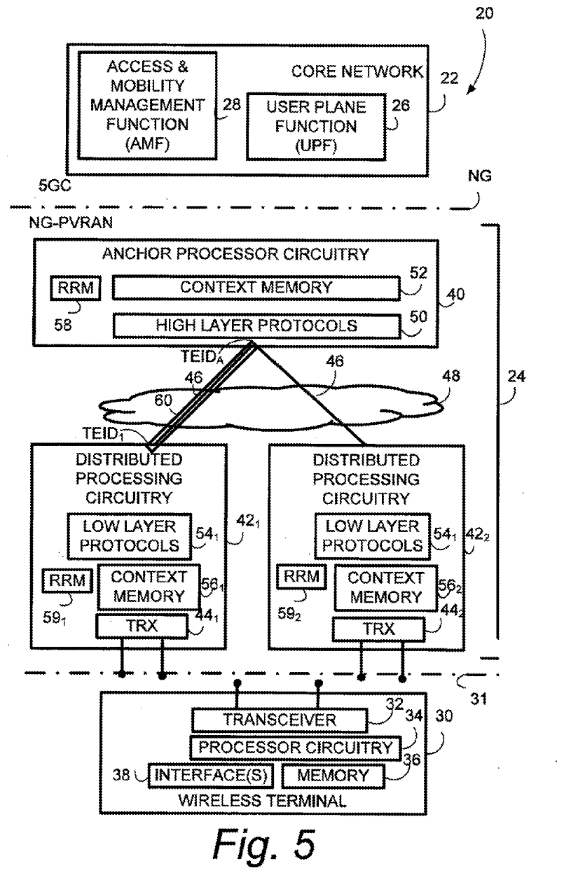

FIG. 5 illustrates a telecommunication network 20 which comprises core network 22 and radio access network 24. For sake of non-limiting, example illustration, the core network 22 is illustrated as being a 5G core network, and thus the radio access network 24 is shown as connected to core network 22 over an interface labeled as the NG interface. Although the radio access network 24 is illustrated as using some terminology and functionality of a New Generation (NG) radio access network, as described further herein the radio access network 24 differs from the radio access network of FIG. 1, for example, in being a packetized virtual radio access network, PVRAN. The fact that the core network 22 and radio access network 24 are described somewhat in 5G terms does not limit the networks to being 5G networks, as the structure and operation of radio access network 24 as described herein has applicability to other networks as well.

As understood by those skilled in the art, when the core network 22 is a 5G core network, the 5G core network 22 performs various core network functions, such as an access and mobility management function (AMF); session management function; user plane function (UPF); policy control function (PCF); authentication server function (AUSF); unified data management (UDM) function; application function (AP); network exposure function (NEF); NF repository function (FRF); and network slice selection function (NSSF). As representative ones of these functions, user plane function (UPF) 26 and access and mobility management function (AMF) 28 are illustrated in FIG. 5.

The radio access network 24 serves one or more wireless terminals 30 which communicate over an air or radio interface 31 with radio access network 24, only one such wireless terminal 30 being shown in FIG. 5 for simplicity. Generally speaking, a wireless terminal 30 may comprise a transceiver 32 and processor circuitry 34 which executes one or more programs or code in an operating system and one or more application programs, which may be stored in non-transient memory 36. The wireless terminal 30 may also include user interface 38.

FIG. 5 further shows that packetized virtual radio access network 24 comprises anchor processor circuitry 40 and distributed processor circuitry 42. The distributed processor circuitry 42 is associated with, e.g., may comprise or be connected to, transceiver circuitry 44. FIG. 5 shows anchor processor circuitry 40 as being connected through packet network 48 by pipes or channels 46 to two distributed processor circuits, particularly to distributed processor circuitry 42₁ and distributed processor circuitry 42₂, although any number of distributed processor circuits 42 may be connected to anchor processor circuitry 40. The distributed processor circuits 42, each having associated transceiver circuitry 44, are preferably located at different geographical sites, in a manner such as of conventional base station nodes. As such, the distributed processor circuits 42₁ and 42₂ are also referred to distributed processor circuitry sites. Plural distributed processor circuitry sites may comprise the overall distributed processor circuitry 42.

The elements of radio access network 24 as described above may also be known by other names. For example, the anchor processor circuitry 40 may be referred to as an “anchor central unit”, or “anchor CU”, for example. The distributed processor circuitry 42, since it may comprise the transceiver circuitry 44, may be referred to as a “radio/DU” or “radio/distributed unit”. The transceiver circuitry 44 may be referred to as a “radio part”, or “radio head”, for example. The transceiver circuitry 44 may comprise both transmitter circuitry and receiver circuitry, and typically includes antenna(e). For its transmitter circuitry the transceiver circuitry 44 may include, e.g., amplifier(s), modulation circuitry and other conventional transmission equipment. For its receiver circuitry the transceiver circuitry 44 may comprise, e.g., amplifiers, demodulation circuitry, and other conventional receiver equipment.

The anchor processor circuitry 40 is configured to perform high layer radio access network node operations for a connection with a wireless terminal. As such, FIG. 5 shows anchor processor circuitry 40 as executing certain high layer protocols 50. In addition, the distributed processor circuitry 42 is configured to generate and maintain a context for the connection with the wireless terminal. FIG. 5 thus shows anchor processor circuitry 40 as comprising context memory 52.

In contrast to anchor processor circuitry 40, the distributed processor circuitry 42 is configured to perform low layer radio access network node operations for the connection with the wireless terminal. FIG. 5 accordingly shows distributed processor circuitry 42 as executing lower layer protocols 54. In addition, distributed processor circuitry 42 comprises context memory 56.

The distributed processor circuitry 42 may comprise one or more distributed processor circuitry sites such as sites 42₁ and 42₂. The distributed processor circuitry 42 is connected to anchor processor circuitry 40 through packet network 48. The packet network 48 may comprise, for example, an Internet Protocol (IP) packet network, although other types of packet networks are also possible. For a given connection with a wireless terminal, the anchor processor circuitry 40 is configured to provide a first endpoint TEID_{A} for a tunnel 60 through which the connection is carried over packet network 48 to the distributed processor circuitry 42, and the distributed processor circuitry 42 is configured to provide a second endpoint for tunnel 60. The second endpoint for the tunnel 60 at the distributed processor circuitry 42 depends on the particular distributed processor circuitry site to which the tunnel 60 is connected. For example, when the tunnel 60 is connected to distributed processor circuitry site 421, the second endpoint of tunnel 60 is labeled as TEID₁.

For each connection handled by the radio access network, a “context”, sometimes referred to as a “UE context”, is generated and maintained. As used herein, “context” or “UE context” may include such items of information as an identification of the wireless terminal involved in the connection; encryption keys for the wireless terminal; parameters associated with each of the protocol layers; and other information (such as whether the wireless terminal is moving, measurement activity by the wireless terminal, etc.). The context for a UE connection may be spread throughout a system, e.g., to different elements which support or are involved in the UE connection. For example, for a given UE context there may be contexts in an IMS application server, Core network elements, and various RAN elements, for example. Therefore, the UE connection may be viewed as having plural “contexts”, e.g., a different portion of the overall UE context perhaps being stored at variously throughout the system. The contexts are generated when the UE powers up and performs registration (e.g., attach procedures). These contexts may have variations in terms of attributes and IE depending on the functionality of the node. The contexts may be stored, maintained, and used by radio resource management (RRM) functionality, which may comprise or be included in Controlling Software or the Operation System.

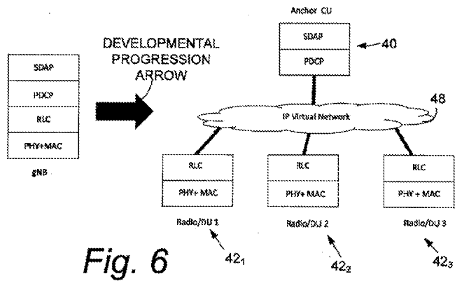

In an example embodiment and mode, the radio resource management (RRM) functionality is split between anchor processor circuitry 40 and distributed processor circuitry 42. FIG. 5 therefore shows that anchor processor circuitry 40 comprises anchor radio resource management (RRM) controller 58 and that distributed processor circuitry 42 comprises distributed radio resource management (RRM) controller 59. As such, the distributed processor circuitry 42 includes at least some of the radio resource management (RRM) functionality. The anchor radio resource management (RRM) controller 58 manages and stores certain context content in context memory 52, the distributed radio resource management (RRM) controller 59 manages and stores certain context content in context memory 56. The context stored in context memory 56 of distributed processor circuitry of a distributed processor circuitry site 42 includes information pertaining to admission control, including resource allocation and tracking for all UEs within the coverage area of the particular distributed processor circuitry site. The context stored in context memory 52 of anchor processor circuitry 40 includes information pertaining to IP connectivity contexts, Identifications, TEIDs, security keys, and mobility-related contexts. FIG. 6 provides further illustration of how protocols handled by the radio access network 24 are split into high layer protocols and low layer protocols, and does do in contrast to the conventional 5G gNodeB protocol stack. A portion of FIG. 6 to the left of the developmental progression arrow shows that the conventional 5G unified gNodeB handles a protocol stack comprising, from lowest to highest protocol layer: physical layer (PHY) and medium access control (MAC) protocols; radio link control (RLC) protocol; Radio Packet Data Convergence (PDCP) protocol; and Service Data Adaptation Protocol (SDAP) protocol. The portion of FIG. 6 to the right of the developmental progression arrow shows the radio access network 24 of the technology disclosed herein, featuring the anchor processor circuitry 40, also known as the anchor CU, and three distributed processor circuitry sites 42₁, 42₂, and 42₃. The high layer protocols 50 of the anchor processor circuitry 40 are shown in FIG. 6 as comprising the Radio Packet Data Convergence (PDCP) protocol and the Service Data Adaptation Protocol (SDAP), whereas the lower layer protocols 54 of the distributed processor circuitry 42 is shown as comprising the physical layer and medium access control (MAC) protocols and the radio link control (RLC) protocols. Thus, the high layer radio access network node operations comprise a Service Data Adaptation Protocol (SDAP) operation and a Packet Data Convergence Protocol (PDCP) operation; whereas the low layer radio access network node operations comprise a radio link control (RLC) operation and a medium access control (MAC) operation.

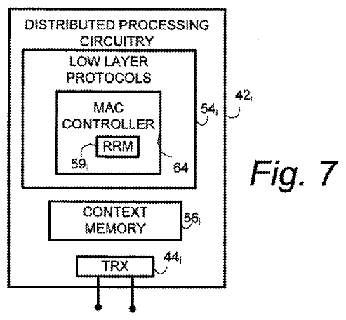

As indicated above, the low layer radio access network node operations comprise a medium access control (MAC) operation. At the distributed processor circuitry 42 the medium access control (MAC) operation is executed by a MAC controller or MAC entity, such as MAC controller 64 shown in the representative distributed processor circuitry cite 42i of FIG. 7. Advantageously, the MAC protocol, and MAC controller 64 in particular, handles at least some of the radio resource management (RRM) functionality required for a connection between the wireless terminal and the radio access network. FIG. 7 thus shows that the distributed radio resource management (RRM) controller distributed radio resource management (RRM) controller 59 for distributed processor circuitry 42i may be included in or comprise the MAC controller 64.

In an example embodiment and mode, all RRC messages may be terminated at the MAC layer, and hence become MAC Control Functions. For example, in an example embodiment and mode, the MAC controller 64 is configured to handle the data radio bearers, DRBs, and signaling radio bearers, SRBs, for the connection. This means that, for such example embodiment and mode, preferably the MAC controller 64 allocates, modifies, and releases all data radio bearers, DRBs, and signaling radio bearers, SRBs, for the connection.

In addition, in an example embodiment and mode, all security/encryption functions are moved from the Radio Packet Data Convergence (PDCP) layer to the MAC layer, e.g., are negotiated by MAC controller 64. Performing the security functions at the MAC layer allows for faster key exchanges and session establishment. Keeping a same context after handover from one distributed processor circuitry site to another means that the same encryption keys may be utilized after the handover as before the handover, which eliminates the need for further security negotiation, and thus conserves processing resources and expedites the handover. As used herein, keeping a “same context” in a handover operation means at least one and preferably both of the following:: (1) that the context maintained by anchor radio resource management (RRM) controller 58 for the anchor processor circuitry 40 remains the same after the handover as before the handover, e.g., that there is substantially no change in context information as used by the anchor processor circuitry 40 for the involved connection after the handover; and (2) that the context information as used by the distributed processor circuitry 42 for the connection involving the wireless terminal does not change when the wireless terminal is handed over from one distributed processor circuitry site to another distributed processor circuitry site.

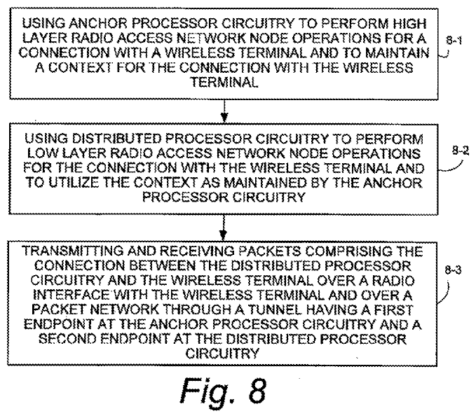

FIG. 8 shows example, basic, representative acts or steps performed by the radio access network 24 of FIG. 5 according to a basic embodiment and mode of the technology disclosed herein. Act 8-1 comprises using anchor processor circuitry to perform high layer radio access network node operations for a connection with a wireless terminal and to maintain a context for the connection with the wireless terminal. Act 8-2 comprises using distributed processor circuitry to perform low layer radio access network node operations for the connection with the wireless terminal and to utilize the context as used by the anchor processor circuitry. Act 8-3 comprises transmitting and receiving packets comprising the connection, both between the distributed processor circuitry and the wireless terminal over a radio interface with the wireless terminal and over a packet network through a tunnel having a first endpoint at the anchor processor circuitry and a second endpoint at the distributed processor circuitry.

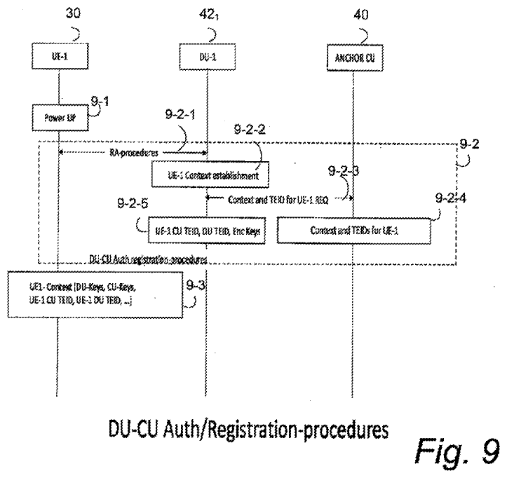

FIG. 9 shows example, representative, basic acts or steps involved in an authentication and registration procedure between a wireless terminal and the radio access network of FIG. 5 according to an example embodiment and mode. Act 9-1 comprise the wireless terminal 30 performing a power up operation. Upon completion of the power up operation of act 9-1, an authentication and registration procedure 9-2 is performed between the wireless terminal 30 and radio access network 24. As a first aspect of the authentication and registration procedure 9-2, a random access procedure 9-2-1 is performed between wireless terminal 30 and one of the distributed processor circuits, such as distributed processor circuitry 42₁ in the present example scenario. After the wireless terminal 30 is granted access, and as a second aspect of the authentication and registration procedure 9-2, as act 9-2-2 a UE context for the wireless terminal 30 is established at distributed processor circuitry 42₁. The UE context is stored in context memory 56 of the distributed processor circuitry 42₁. As a third aspect of the authentication and registration procedure 9-2, as act 9-2-3 a tunnel endpoint for the connection is established at the distributed processor circuitry 42 and both the UE context and the tunnel endpoint for the connection are signaled to anchor processor circuitry 40. The tunnel endpoint may be, for example, endpoint TEID₁ shown in FIG. 5. The tunnel endpoint TEID₁ is the endpoint for the tunnel for the access permitted-connection for wireless terminal 30. In conjunction with a fourth aspect of the authentication and registration procedure 9-2, as act 9-2-4 the UE context is stored in context memory 52 of anchor processor circuitry 40. Moreover, the tunnel endpoint TEID₁ at distributed processor circuitry 42₁ for this connection with the wireless terminal 30 is noted by anchor processor circuitry 40. As act 9-2-5 the MAC controller 64 of distributed processor circuitry 42₁ conducts an authentication procedure whereby security keys are negotiated for anchor processor circuitry 40 and distributed processor circuitry 42₁ for this connection with the wireless terminal 30. The authentication procedure typically results in the generation of security keys for the distributed processor circuitry 42, e.g., DU-Keys, and security keys for the anchor processor circuitry 40, e.g., CU-Keys. Also the distributed processor circuitry 42₁ receives the identifier of the tunnel endpoint for tunnel 60 at the anchor processor circuitry 40, e.g., receives the endpoint identifier TEID_{A} of FIG. 5, for example. As act 4-3 the wireless terminal 30 is provided by distributed processor circuitry 42₁ with the UE context, as well as the endpoints for tunnel 60, e.g., both TEID_{A}=UE-1 CU TEID and TEID₁=UE-1 DU TEID, and the encryption keys e.g., the encryption key for distributed processor circuitry 42₁ (DU-keys) and the encryption key for anchor processor circuitry 40 (CU-keys).

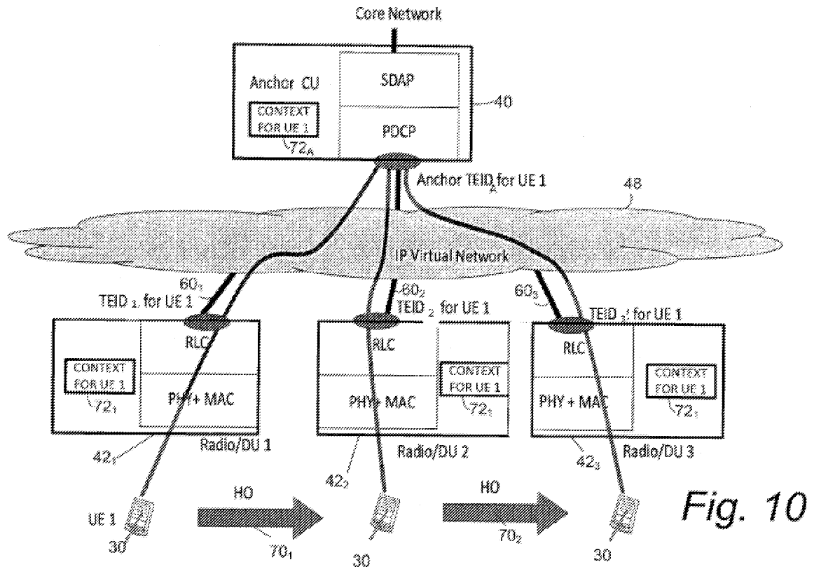

As understood from FIG. 5 and the preceding discussion, the transceiver circuitry 44 may comprise plural transceivers, such as transceiver circuitry 44₁ and transceiver circuitry 44₂, any possibly other transceiver circuits as well, located at different sites. Similarly, the distributed processor circuitry 42 may comprise plural distributed processor circuitry sites such as the sites 42₁ and 42₂ shown in FIG. 5, or even a greater number of plural sites as indicated by sites 42₁, 42₂, and 42₃ shown in FIG. 6, FIG. 9, and FIG. 10.

FIG. 10 shows handover of a wireless terminal between various distributed processor circuitry sites, such as the sites of FIG. 6 and FIG. 9. FIG. 10 shows by arrow 70₁ a first handover of wireless terminal 30, e.g., UE 1, from distributed processor circuitry 42₁ to distributed processor circuitry 42₂, and by arrow 70₂ a second handover of wireless terminal 30 from distributed processor circuitry 42₂ to distributed processor circuitry 42₃. Usage of the term “handover” herein should be understood to encompass and/or include a “handoff” to the extent, if any, that the terms have any different meaning.

The plural distributed processor circuitry sites 42 are configured so that, upon a handover of the connection with the wireless terminal from a first distributed processor circuitry site to a second distributed processor circuitry site, the same context may be utilized for the connection involving the wireless terminal. In other words, the second distributed processor circuitry site after the handover uses a same context for the connection as was used by the first distributed processor circuitry site before the handover. Moreover, the anchor processor circuitry 40 may use the same context for the connection after the handover as it used before the handover.

FIG. 10 illustrates that, at the time of initial setup of the connection for wireless terminal 30 UE 1, UE context 72_{A} for UE 1 is established in context memory 52 of anchor processor circuitry 40, and a corresponding context 72₁ is established at distributed processor circuitry 42₁. As indicated above, the context 72_{A} stored in context memory 52 of anchor processor circuitry 40 may include information pertaining to IP connectivity contexts, Identifications, TEIDs, security keys, and mobility-related contexts. On the other hand, the context 721 stored in context memory 56 may include context information pertaining to admission control, including resource allocation and tracking for all UEs within the coverage area of the particular distributed processor circuitry site. Before the handover of the connection involving wireless terminal 30 indicated by arrow 70₁, the anchor processor circuitry 40 and distributed processor circuitry 42₁ communicate over tunnel 60₁, the tunnel 60₁ having endpoints TEID_{A} and TEID₁.

After the handover of the connection involving wireless terminal 30 indicated by arrow 70₁, the anchor processor circuitry 40 and distributed processor circuitry 42₂ communicate over tunnel 60₂, the tunnel 60₂ having endpoints TEID_{A} and TEID₂. The second endpoint of the tunnel changes as a result of the handover, but the UE context 72 as utilized by the distributed processor circuitry 42 for the involved wireless terminal 30, e.g., UE 1, remains the same after the handover indicated by arrow 72₁. In other words, a new context for the wireless terminal 30 does not need to be established within the distributed processor circuitry 42 as a result of the handover, with the result that the content of the original UE context 72₁ established when the connection existed at distributed processor circuitry site 42₁ can be used at the distributed processor circuitry site 42₂ and thus does not have to be changed or a new context generated and signaled between anchor processor circuitry 40 and distributed processor circuitry 42₂ because of the handover. Accordingly, when the connection is handed over to distributed processor circuitry site 42₂ the same UE context 72₁ can be utilized at the distributed processor circuitry site 42₂ as was used when the connection was at distributed processor circuitry site 42₁. Moreover, the context 72_{A} as used by the anchor processor circuitry 40 before the handover can also be used after the handover.

FIG. 10 further illustrates by arrow 70₂ that the connection involving wireless terminal 30, e.g., UE 1, may be further handed over from distributed processor circuitry site 42₂ to distributed processor circuitry site 42₃. After the handover indicated by arrow 70₂, the anchor processor circuitry 40 and distributed processor circuitry 42₃ communicate over tunnel 60₃, the tunnel 60₃ having endpoints TEID_{A} and TEID₃. Again, the second endpoint of the tunnel changes as a result of the handover, but the UE context 72₁ for the involved wireless terminal 30, e.g., UE 1, remains the same after the handover indicated by arrow 72₂. Thus a new context for the wireless terminal 30 does not need to be established as a result of the handover, with the result that the content of the original UE context 72₁ established when the connection existed at distributed processor circuitry site 42₁ does not have to be changed or a new context generated and signaled between anchor processor circuitry 40 and distributed processor circuitry 42₃. Thus again, when the connection is handed over to distributed processor circuitry site 42₃ the same UE context 72₁ can be utilized as was used when the connection was at distributed processor circuitry site 42₃. As in the case of the earlier handover indicated by arrow 70₁, the context 72_{A} as used by the anchor processor circuitry 40 before the handover indicated by arrow 70₂ can also be used after that handover.

Since the same UE context 72₁ is essentially handed over between the different distributed processor circuitry sites as the connection involving wireless terminal 30 is handed over, the contents of the UE context 72₁ need not be re-negotiated, thus eliminating considerable signaling between the anchor processor circuitry 40 and the handed-over-to distributed processor circuitry site. The UE context 72₁ includes many elements of information, none of which thus need to be changed or re-negotiated. Among the elements of the UE context 72₁ is encryption information, e.g., encryption keys, such as the encryption or security keys CU-Keys and DU-keys illustrated in and discussed in conjunction with FIG. 9, for example. Moreover, the UE context 72_{A} for the connection involving wireless terminal 30, as initially set up for the connection, can be maintained at anchor processor circuitry 40 regardless of subsequent handover. In other words, after the handover indicated by arrow 70₁, the anchor processor circuitry 40 still maintains the same UE context 72_{A} for the connection through distributed processor circuitry 42₂, and after the handover indicated by arrow 70₁, the anchor processor circuitry 40 still maintains the same UE context 72_{A} for the connection through distributed processor circuitry 42₃.

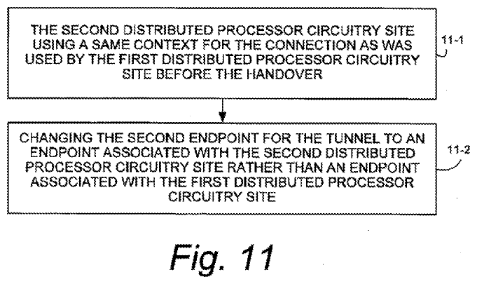

A handover such as that depicted by FIG. 10 is also illustrated by a handover operation having example, representative acts or steps as shown in FIG. 11. It is understood that, in a handover scenario, the transceiver circuitry 44 comprises plural transceivers, such as transceivers 44₁, 44₂, . . . ; the distributed processor circuitry 42 comprises plural distributed processor circuitry sites, e.g., distributed processor circuitry sites 42₁, 42₂, . . . ; and each of the plural distributed processor circuitry sites is associated with a respective one of the plural transceivers. According to a basic example embodiment and mode, upon a handover of the connection with the wireless terminal from a first distributed processor circuitry site to a second distributed processor circuitry site, acts 11-1 and 11-2 are performed. Act 11-1 comprises the second distributed processor circuitry site using a same context for the connection as was used by the first distributed processor circuitry site before the handover. Act 11-2 comprises changing the second endpoint for the tunnel to an endpoint associated with the second distributed processor circuitry site rather than an endpoint associated with the first distributed processor circuitry site.

There may be several different variation of handover procedures. For example, in Network-based handover the anchor processor circuitry 40 triggers the handover and determine the target distributed processor circuitry site 42. In such case, the anchor processor circuitry 40 may install the same context, e.g., context 72₁, in the new distributed processor circuitry site and establish the TEID for the new distributed processor circuitry site, and then communicate that back to the wireless terminal in a handover command. In another embodiment of handover procedure, a first distributed processor circuitry site may trigger the handover and may determine the target or second distributed processor circuitry site, after which the same context, e.g., context 72₁, may be installed in the target distributed processor circuitry site either directly via a direct interface (e.g., Xn interface) or indirectly through the anchor processor circuitry 40. Either way a new TEID is established at the new or second distributed processor circuitry site and a new tunnel with the anchor processor circuitry 40 is established. Related information will be communicated to the wireless terminal so that the wireless terminal can perform the handover to the target distributed processor circuitry site). In yet another embodiment of handover procedure, the wireless terminal may trigger the handover and the wireless terminal may determine the target distributed processor circuitry site for the handover. In this third embodiment the wireless terminal UE may also communicate information to the source distributed processor circuitry site to perform the Tunnel establishment before the actual handover (e.g., in make before break fashion), or the wireless terminal may initiate the handover to the target distributed processor circuitry site, with the result that the new or target distributed processor circuitry site may retrieve the context from the source distributed processor circuitry site either directly (e.g., through the Xn interface(or indirectly through the anchor processor circuitry 40. In either case the wireless terminal may provide the identification of the source distributed processor circuitry site and/or the identification of the anchor processor circuitry 40. The target distributed processor circuitry site may then request the contexts using these identifications. The target distributed processor circuitry site may also establish the TEID for the tunnel with the CU.

It should thus be apparent that shifting of many radio access network functions from high protocol layers to low protocol layers, e.g., the protocol layers handled by the distributed processor circuitry 42, in the manner of the technology disclosed herein, facilitates faster establishment and tear-down of connections and faster handover.

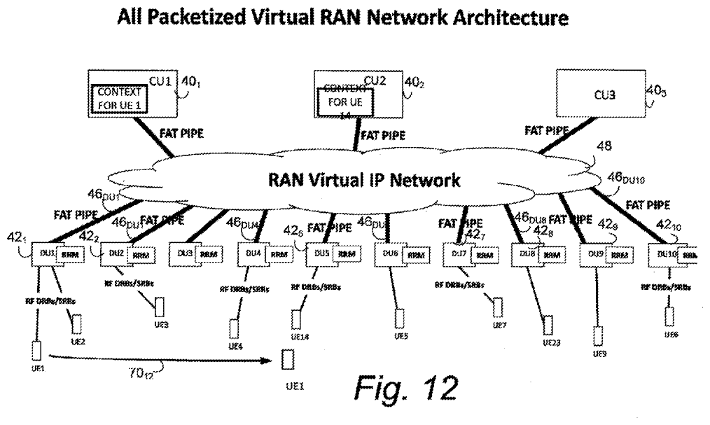

According to another example embodiment and mode illustrated in FIG. 12, the anchor processor circuitry 40 may comprise plural anchor processor circuitry servers, such as plural anchor processor circuitry server 40₁ through 40₃, also illustrated and known as CU1 through CU3. The plural anchor processor circuitry servers are connected through packet network 48 to the plural distributed processor circuitry sites 42₁-42₁₀ comprising the distributed processor circuitry 42. As such each of the plural anchor processor circuitry servers 40 is connected by the packet network 48 to one or more of the plural distributed processor circuitry sites 42₁-42₁₀.

One non-limiting example advantage of the packetized virtual radio access network 40 of FIG. 12 is that an initial anchor processor circuitry server involved in initial setup of the connection is configured to maintain the context for the connection with the wireless terminal regardless of to which of the plural distributed processor circuitry sites the connection is handed over. For example, suppose in the FIG. 12 scenario that a connection is initially setup between anchor processor circuitry 40₁ and wireless terminal UE 1 through distributed processor circuitry site 42₁. The connection between anchor processor circuitry 40₁ and wireless terminal UE 1 through distributed processor circuitry site 42₁ involves UE context 72₁, as understood with reference to the previous discussion of FIG. 10. FIG. 12 also shows that another connection is setup between anchor processor circuitry 40₂ and wireless terminal UE 14 through distributed processor circuitry site 42₅. After setup of the initial connection involving wireless terminal UE 1, further suppose that wireless terminal UE 1 is involved in a handover and is handed over to distributed processor circuitry site 42₅, as shown by arrow 70₁₂. Despite the handover of wireless terminal UE 1 to a distributed processor circuitry site such as distributed processor circuitry site 42₅ that is handling a connection routed to another anchor processor circuitry server 40₂, e.g., the connection involving wireless terminal UE 14, the connection involving wireless terminal UE 1 is still with anchor processor circuitry server 40₁ and the same UE context 72₁ for the wireless terminal UE 1 can be utilized while the connection is routed through and served by distributed processor circuitry site 42₅. FIG. 12 thus illustrates the distributed processor circuitry sites 42₁-42₁₀ are flexibly associated with the plural anchor processor circuitry servers 40, with the result that an initial anchor processor circuitry server involved in initial setup of the connection maintains the context for the connection regardless of to which distributed processor circuitry site the connection is handed over. Thus, the wireless terminal, as it moves between distributed processor circuitry sites 42, does not need to change between plural anchor processor circuitry servers 40 as long as the wireless terminal remains in the same packetized virtual radio access network. Viewed another way, a migrating wireless terminal is not obligated to change to another plural anchor processor circuitry server in view of the particular distributed processor circuitry site to which it has been handed over. In other words, a particular distributed processor circuitry site is required to utilize a particular plural anchor processor circuitry server This assures continuity of delivery.

As a corollary of the foregoing, a particular distributed processor circuitry site may use one anchor processor circuitry server for a first connection, e.g., with UE 1, and another plural anchor processor circuitry server for a second connection, e.g., with UE 14.

As described herein, pipes 46 are packet connections, e.g., IP connections, which are used to connect the various processor circuitries to the packet network 48. In view of advantages of the technology disclosed herein such as, for example, the reusability of contexts, the bandwidth required for a particular connection may be less than for a conventional radio access network. But preferably the pipes 46 have large bandwidth for the sake of accommodate numerous connections, e.g., connections involving plural wireless terminals, perhaps with some of the wireless terminals being involved in plural connections. In view of the large bandwidth, the pipes 46 may be referred to herein an illustrated as “fat pipes”. The concept of a FAT PIPE may be implemented between the anchor processor circuitry 40 and all distributed processor circuitry sites 42 where the wireless terminal does not have to initiate or reconfigure all the layering (e.g., MAC, RLC, PDCP, SDAP) for individual pipes or bearers that it needs to establish connectivity within the radio access network.

The radio access network 24 fully implement a packet model rather than the dedicated Circuit model where individual SRBs and DRBs are established for individual UEs and for particular services. Moreover, the MAC protocol layer, e.g., MAC controller 64, at the distributed processor circuitry site 42 may be able to receive data from wireless terminal s over the air and multiplex these data packets and forward them to anchor processor circuitry 40 without any impact or degradations. The anchor processor circuitry 40 may be able to process these packets and forward them to the appropriate destination depending on their headers rather than its PIPE ID. In the prior art, all RRC messages have to go through all layers of the protocol stack of the gNB shown in FIG. 6. This involves a separate instance in the UE for each layer of the protocol stack. Whenever a UE establishes or re-establishes a connection, e.g., at a handover, the instance for each layer must be established or re-established. Repeated establishment and re-establishment of the instances for each protocol layer on occasion of a handover, for example, utilizes considerable signaling, processing power, and time. As one of its advantages the technology disclosed herein addresses the signaling, processing power, and time concerns by separating the protocol stack so that only certain high layer protocols are executed at the anchor processor circuitry 40, and certain low layer protocols are moved to and executed at the distributed processor circuitry 42, at the distributed processor circuitry sites. In particular, at least some functionality of the Radio Resource Management (RRM) is moved to the radio unit, e.g., to distributed processor circuitry 42. When a channel is needed, the channel can be obtained at the distributed processor circuitry 42 rather than having to request the channel from the anchor processor circuitry 40. The technology disclosed herein achieves the desired connectivity, and sets up and flows in a faster way.

Some aspects of telephone technology years ago migrated from a circuit switched philosophy, involving dedicated wires or connections, to a packet switched philosophy, in which packets could take any route between source and destination. In a similar migratory manner, the Network Function Virtualization (NFV) radio access network of the technology disclosed herein flexibly routes packets transmitted through the radio access network between a wireless terminal and anchor processor circuitry without requiring a dedicated or unchangeable path for the packets, as illustrated, for example, by FIG. 12.

The technology disclosed herein advantageously reduces signaling and expedites session establishment, re-establishment, resume, and ON-OFF operations. For example, upon handover from one distributed processor circuitry site to another, the procedures performed at the anchor processor circuitry 40 may remain essentially the same, resulting in significant savings and efficiency.

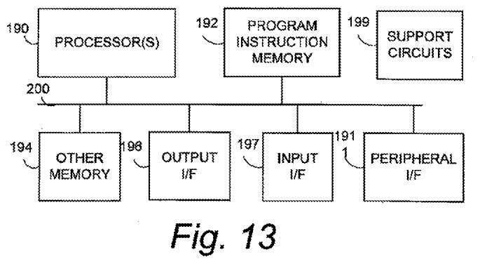

Among its various embodiments and modes, the technology disclosed herein includes one or more of the following features and/or benefits, which may be achieved either alone or in combination:
Use of a single FAT IP PIPE to connect DU and CU, e.g., to connect anchor processor circuitry 40 and distributed processor circuitry 42, for all DRBs and SRBs traffic.
Packets being multiplexed over the FAT IP PIPE may use a new header to identify the UE, Session ID, and QoS.
Radio Resource Management (RRM) functionality is split between DU and CU.
Admission control and physical radio resource and bandwidth managements/allocations_ for SRBs and DRBs, and local (Intra) mobility are allocated at the DU, e.g., at the distributed processor circuitry 42.
Inter-Node mobility is controlled by the CU.
All Radio Resource Management messaging (e.g., Radio establishment, re-establishment, release, resume, reconfigurations, etc.) is done at the DU level.
No configuration/re-configurations of MAC, RLC, PDCP, SDAP are required while the wireless terminal remains within the RAN Virtual IP network.
Radio Resources allocations (Grants, Semi-Persistence SPS, or Persistence) and release are managed at the MAC level, e.g., by MAC controller 64 at the distributed processor circuitry 42.
A session is anchored at the CU, e.g., at anchor processor circuitry 40, while the wireless terminal is roaming within the same RAN Virtual IP network, where the DU uses the TEIDs of the CU to forward SRB/DRB packets to the appropriate CU.
End-to-End Security keys may be established between the CU and wireless terminal and the security keys last for the duration of the session while the wireless terminal is connected to the CU.
Local Security Keys may be established over the air between the wireless terminal UE and the distributed processor circuitry 42, e.g., the DU.
Inter-node mobility between CUs belonging to different RAN Virtual IP network.
A backward compatible mode with 5G and LTE is achieved using IP tunneling of RRC messaging, Protocol primitives, and configurations information of 5G and/or LTE message formats.
   Network Function Virtualization (NFV) may be further described by one or more of the following(all of which are incorporated herein by reference in their entirety):
RP-181932, “Work Item on Support for Virtualized RAN in NR”, 3GPP TSG RAN Meeting #81, Gold Coast, Australia, 10-13 Sep. 2018.
3GPP TR 38.913 V15.0.0 (2018-06), “Study on scenarios and requirements for next generation access technologies”, 3rd Generation Partnership Project; Technical Specification Group Radio Access Network; Study on Scenarios and Requirements for Next Generation Access Technologies; (Release 15).
3GPP TR 38.801 V14.0.0 (2017-03); 3rd Generation Partnership Project; Technical Specification Group Radio Access Network; Study on new radio access technology: Radio access architecture and interfaces (Release 14); Study on new radio access technology: Radio access architecture and interfaces.
   Certain units and functionalities of radio access network 24 may be implemented by electronic machinery. For example, electronic machinery may refer to the processor circuitry described herein, such as anchor processor circuitry 40 and distributed processor circuitry 42. Moreover, the term “processor circuitry” is not limited to mean one processor, but may include plural processors, with the plural processors operating at one or more sites. Moreover, as used herein the term “server”, as in plural anchor processor circuitry servers 40 , is not confined to one server unit, but may encompasses plural servers and/or other electronic equipment, and may be co-located at one site or distributed to different sites. With these understandings, FIG. 13 shows an example of electronic machinery, e.g., processor circuitry, as comprising one or more processors 190, program instruction memory 192; other memory 194 (e.g., RAM, cache, etc.); input/output interfaces 196 and 197, peripheral interfaces 198; support circuits 199; and busses 200 for communication between the aforementioned units. The processor(s) 190 may comprise the processor circuitries described herein, for example, the anchor processor circuitry 40 and distributed processor circuitry 42 distributed processor circuitry 42.

The memory 194, or computer-readable medium, may be one or more of readily available memory such as random access memory (RAM), read only memory (ROM), floppy disk, hard disk, flash memory or any other form of digital storage, local or remote, and is preferably of non-volatile nature, as and such may comprise memory 60 shown in FIG. 5. The support circuits 199 are coupled to the processors 190 for supporting the processor in a conventional manner. These circuits include cache, power supplies, clock circuits, input/output circuitry and subsystems, and the like.

Although the processes and methods of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routines of the disclosed embodiments are capable of being executed on any computer operating system, and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Nodes that communicate using the air interface also have suitable radio communications circuitry. Moreover, the technology disclosed herein may additionally be considered to be embodied entirely within any form of computer-readable memory, such as solid-state memory, magnetic disk, or optical disk containing an appropriate set of computer instructions that would cause a processor to carry out the techniques described herein.

Moreover, each functional block or various features of the wireless terminal 30 and radio access network 24 used in each of the aforementioned embodiments may be implemented or executed by circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

The technology disclosed herein thus comprises and compasses the following non-exhaustive example embodiments and modes:

Example Embodiment 1: A radio access network comprising:

anchor processor circuitry configured to perform high layer radio access network node operations for a connection with a wireless terminal;

distributed processor circuitry configured to perform low layer radio access network node operations for the connection with the wireless terminal and to utilize the context as used by the anchor processor circuitry;

transceiver circuitry associated with the distributed processor circuitry and configured to transmit and receive packets comprising the connection over a radio interface with the wireless terminal;

wherein the anchor processor circuitry is configured to provide a first endpoint for a tunnel through which the connection is carried over a packet network to the distributed processor circuitry, and wherein the distributed processor circuitry is configured to provide a second endpoint for the tunnel.

Example Embodiment 2: The radio access network of Example Embodiment 1, wherein:

the high layer radio access network node operations comprise:
a Service Data Adaptation Protocol (SDAP) operation; and
a Packet Data Convergence Protocol (PDCP) operation;

the low layer radio access network node operations comprise:
a radio link control (RLC) operation; and
a medium access control (MAC) operation.
   Example Embodiment 3: The radio access network of Example Embodiment 1, wherein the low layer radio access network node operations comprise a medium access control (MAC) operation, and wherein at least some radio resource management functionality required for the connection is handled by a medium access controller of the distributed processor circuitry.

Example Embodiment 4: The radio access network of Example Embodiment 1, wherein the low layer radio access network node operations comprise a medium access control (MAC) operation, and wherein the distributed processor circuitry comprises a medium access control (MAC) controller configured to handle data radio bearers and signaling radio bearers for the connection.

Example Embodiment 5: The radio access network of Example Embodiment 1, wherein:

the transceiver circuitry comprises plural transceivers;

the distributed processor circuitry comprises plural distributed processor circuitry sites, each of the plural distributed processor circuitry sites being associated with a respective one of the plural transceivers;

the plural distributed processor circuitry sites being configured whereby upon a handover of the connection involving the wireless terminal from a first distributed processor circuitry site toa second distributed processor circuitry site, the second distributed processor circuitry site uses a same context for the connection as was used by the first distributed processor circuitry site before the handover, and wherein the anchor processor circuitry uses a same context for the connection as used by the anchor processor circuitry after the handover as before the handover, but wherein the second endpoint for the tunnel is an endpoint associated with the second distributed processor circuitry site rather than an endpoint associated with the first distributed processor circuitry site. Example Embodiment 6: The radio access network of Example Embodiment 5, wherein the same context comprises same encryption information and thereby obviates another encryption negotiation due to the handover.

Example Embodiment 7: The radio access network of Example Embodiment 1, wherein:

the anchor processor circuitry comprises plural anchor processor circuitry servers;

the distributed processor circuitry comprises plural distributed processor circuitry sites,

each of the plural anchor processor circuitry servers is connected by the packet network to one or more of the plural distributed processor circuitry sites;

an initial anchor processor circuitry server involved in initial setup of the connection is configured to maintain the context for the connection with the wireless terminal regardless of to which of the plural distributed processor circuitry sites the connection is handed over.

Example Embodiment 8: The radio access network of Example Embodiment 1, wherein:

the anchor processor circuitry comprises plural anchor processor circuitry servers;

the distributed processor circuitry comprises plural distributed processor circuitry sites,

the distributed processor circuitry sites are flexibly associated with the plural anchor processor circuitry servers whereby an initial anchor processor circuitry server involved in initial setup of the connection maintains the context for the connection regardless of to which distributed processor circuitry site the connection is handed over.

Example Embodiment 9: The radio access network of Example Embodiment 1, wherein the distributed processor circuitry is configured to multiplex through the tunnel radio bearers for plural connections between the anchor processor circuitry and respective plural wireless terminals, and wherein each connection is identified by a header that includes both a wireless terminal identifier and a session identifier.

Example Embodiment 10: The radio access network of Example Embodiment 1, wherein the radio access network is a fifth generation radio access network that connects over a NG interface to a core network.

Example Embodiment 11: A method in a radio access network comprising:
using anchor processor circuitry to perform high layer radio access network node operations for a connection with a wireless terminal and to maintain a context for the connection with the wireless terminal;
using distributed processor circuitry to perform low layer radio access network node operations for the connection with the wireless terminal and to utilize the context as used by the anchor processor circuitry;
transmitting and receiving packets comprising the connection:
   between the distributed processor circuitry and the wireless terminal over a radio interface with the wireless terminal; and
   over a packet network through a tunnel having a first endpoint at the anchor processor circuitry and a second endpoint at the distributed processor circuitry.
      Example Embodiment 12: The method of Example Embodiment 11, wherein:

the high layer radio access network node operations comprise:
a Service Data Adaptation Protocol (SDAP) operation; and
a Packet Data Convergence Protocol (PDCP) operation;

the low layer radio access network node operations comprise:
a radio link control (RLC) operation; and
a medium access control (MAC) operation.
   Example Embodiment 13: The method of Example Embodiment 11, wherein the low layer radio access network node operations comprise a medium access control (MAC) operation, and further comprising handling at least some radio resource management functionality required for the connection by a medium access controller of the distributed processor circuitry.

Example Embodiment 14: The method of Example Embodiment 11, wherein the low layer radio access network node operations comprise a medium access control (MAC) operation, and wherein the distributed processor circuitry comprises a medium access control (MAC) controller, and wherein the method further comprising using the medium access controller to handle data radio bearers and signaling radio bearers for the connection.

Example Embodiment 15: The method of Example Embodiment 11, wherein
the transceiver circuitry comprises plural transceivers;
the distributed processor circuitry comprises plural distributed processor circuitry sites, each of the plural distributed processor circuitry sites being associated with a respective one of the plural transceivers;
wherein the method further comprises, upon a handover of the connection involving the wireless terminal from a first distributed processor circuitry site to a second distributed processor circuitry site for the connection involving the wireless terminal:
the second distributed processor circuitry site using a same context for the connection was used by the first distributed processor circuitry site;
the anchor processor circuitry using a same context for the connection after the handover as used by the anchor processor circuitry before the handover;
changing the second endpoint for the tunnel to an endpoint associated with the second distributed processor circuitry site rather than an endpoint associated with the first distributed processor circuitry site.
   Example Embodiment 16: The method of Example Embodiment 15, further comprising not performing another encryption negotiation due to the handover since the same context comprises same encryption information.

Example Embodiment 17: The method of Example Embodiment 11, wherein:
the anchor processor circuitry comprises plural anchor processor circuitry servers;
the distributed processor circuitry comprises plural distributed processor circuitry sites,
each of the plural anchor processor circuitry servers is connected by the packet network to one or more of the plural distributed processor circuitry sites;
an initial anchor processor circuitry server involved in initial setup of the connection maintains the context for the connection with the wireless terminal regardless of to which of the plural distributed processor circuitry sites the connection is handed over.
   Example Embodiment 18: The method of Example Embodiment 11, wherein:

the anchor processor circuitry comprises plural anchor processor circuitry servers;

the distributed processor circuitry comprises plural distributed processor circuitry sites,

flexibly associating the distributed processor circuitry sites with the plural anchor processor circuitry servers whereby an initial anchor processor circuitry server involved in initial setup of the connection maintains the context for the connection regardless to which distributed processor circuitry site the connection is handed over.

Example Embodiment 19: The method of Example Embodiment 11, further comprising:

multiplexing through the tunnel radio bearers for plural connections between the anchor processor circuitry and respective plural wireless terminals, and

identifying each connection by a header that includes both a wireless terminal identifier and a session identifier.

Example Embodiment 20: The method of Example Embodiment 11, wherein the radio access network is a fifth generation radio access network that connects over a NG interface to a core network
It will be appreciated that the technology disclosed herein is directed to solving radio communications-centric issues and is necessarily rooted in computer technology and overcomes problems specifically arising in radio communications. Moreover, the technology disclosed herein improves basic function of a radio access network, e.g., enabling faster and simplified access to the network and expedited, simplified handover operations.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” The above-described embodiments could be combined with one another. All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims.

What is claimed is:

1. A radio access network comprising:
anchor processor circuitry configured to perform high layer radio access network node operations for a connection with a wireless terminal;
distributed processor circuitry configured to perform low layer radio access network node operations for the connection with the wireless terminal and to utilize the context as used by the anchor processor circuitry;
transceiver circuitry associated with the distributed processor circuitry and configured to transmit and receive packets comprising the connection over a radio interface with the wireless terminal;
wherein the anchor processor circuitry is configured to provide a first endpoint for a tunnel through which the connection is carried over a packet network to the distributed processor circuitry, and wherein the distributed processor circuitry is configured to provide a second endpoint for the tunnel.

2. The radio access network of claim 1, wherein:
the high layer radio access network node operations comprise:
a Service Data Adaptation Protocol (SDAP) operation; and
a Packet Data Convergence Protocol (PDCP) operation;
the low layer radio access network node operations comprise:
a radio link control (RLC) operation; and
a medium access control (MAC) operation.

3. The radio access network of claim 1, wherein the low layer radio access network node operations comprise a medium access control (MAC) operation, and wherein at least some radio resource management functionality required for the connection is handled by a medium access controller of the distributed processor circuitry.

4. The radio access network of claim 1, wherein the low layer radio access network node operations comprise a medium access control (MAC) operation, and wherein the distributed processor circuitry comprises a medium access control (MAC) controller configured to handle data radio bearers and signaling radio bearers for the connection.

5. The radio access network of claim 1, wherein:
the transceiver circuitry comprises plural transceivers;
the distributed processor circuitry comprises plural distributed processor circuitry sites, each of the plural distributed processor circuitry sites being associated with a respective one of the plural transceivers;
the plural distributed processor circuitry sites being configured whereby upon a handover of the connection involving the wireless terminal from a first distributed processor circuitry site to a second distributed processor circuitry site, the second distributed processor circuitry site uses a same context for the connection as was used by the first distributed processor circuitry site before the handover, and wherein the anchor processor circuitry uses a same context for the connection as used by the anchor processor circuitry after the handover as before the handover, but wherein the second endpoint for the tunnel is an endpoint associated with the second distributed processor circuitry site rather than an endpoint associated with the first distributed processor circuitry site.

6. The radio access network of claim 5, wherein the same context comprises same encryption information and thereby obviates another encryption negotiation due to the handover.

7. The radio access network of claim 1, wherein:
the anchor processor circuitry comprises plural anchor processor circuitry servers;
the distributed processor circuitry comprises plural distributed processor circuitry sites, each of the plural anchor processor circuitry servers is connected by the packet network to one or more of the plural distributed processor circuitry sites;
an initial anchor processor circuitry server involved in initial setup of the connection is configured to maintain the context for the connection with the wireless terminal regardless of to which of the plural distributed processor circuitry sites the connection is handed over.

8. The radio access network of claim 1, wherein:
the anchor processor circuitry comprises plural anchor processor circuitry servers;
the distributed processor circuitry comprises plural distributed processor circuitry sites, the distributed processor circuitry sites are flexibly associated with the plural anchor processor circuitry servers whereby an initial anchor processor circuitry server involved in initial setup of the connection maintains the context for the connection regardless of to which distributed processor circuitry site the connection is handed over.

9. The radio access network of claim 1, wherein the distributed processor circuitry is configured to multiplex through the tunnel radio bearers for plural connections between the anchor processor circuitry and respective plural wireless terminals, and wherein each connection is identified by a header that includes both a wireless terminal identifier and a session identifier.

10. The radio access network of claim 1, wherein the radio access network is a fifth generation radio access network that connects over a NG interface to a core network.

11. A method in a radio access network comprising:
using anchor processor circuitry to perform high layer radio access network node operations for a connection with a wireless terminal and to maintain a context for the connection with the wireless terminal;
using distributed processor circuitry to perform low layer radio access network node operations for the connection with the wireless terminal and to utilize the context as used by the anchor processor circuitry;
transmitting and receiving packets comprising the connection:
between the distributed processor circuitry and the wireless terminal over a radio interface with the wireless terminal; and
over a packet network through a tunnel having a first endpoint at the anchor processor circuitry and a second endpoint at the distributed processor circuitry.

12. The method of claim 11, wherein:
the high layer radio access network node operations comprise:
a Service Data Adaptation Protocol (SDAP) operation; and
a Packet Data Convergence Protocol (PDCP) operation;
the low layer radio access network node operations comprise:
a radio link control (RLC) operation; and
a medium access control (MAC) operation.

13. The method of claim 11, wherein the low layer radio access network node operations comprise a medium access control (MAC) operation, and further comprising handling at least some radio resource management functionality required for the connection by a medium access controller of the distributed processor circuitry.

14. The method of claim 11, wherein the low layer radio access network node operations comprise a medium access control (MAC) operation, and wherein the distributed processor circuitry comprises a medium access control (MAC) controller, and wherein the method further comprising using the medium access controller to handle data radio bearers and signaling radio bearers for the connection.

15. The method of claim 11, wherein:
the transceiver circuitry comprises plural transceivers;
the distributed processor circuitry comprises plural distributed processor circuitry sites, each of the plural distributed processor circuitry sites being associated with a respective one of the plural transceivers;
wherein the method further comprises, upon a handover of the connection involving the wireless terminal from a first distributed processor circuitry site to a second distributed processor circuitry site for the connection involving the wireless terminal:
the second distributed processor circuitry site using a same context for the connection was used by the first distributed processor circuitry site;
the anchor processor circuitry using a same context for the connection after the handover as used by the anchor processor circuitry before the handover;
changing the second endpoint for the tunnel to an endpoint associated with the second distributed processor circuitry site rather than an endpoint associated with the first distributed processor circuitry site.

16. The method of claim 15, further comprising not performing another encryption negotiation due to the handover since the same context comprises same encryption information.

17. The method of claim 11, wherein:
the anchor processor circuitry comprises plural anchor processor circuitry servers;
the distributed processor circuitry comprises plural distributed processor circuitry sites, each of the plural anchor processor circuitry servers is connected by the packet network to one or more of the plural distributed processor circuitry sites;
an initial anchor processor circuitry server involved in initial setup of the connection maintains the context for the connection with the wireless terminal regardless of to which of the plural distributed processor circuitry sites the connection is handed over.

18. The method of claim 11, wherein:
the anchor processor circuitry comprises plural anchor processor circuitry servers;
the distributed processor circuitry comprises plural distributed processor circuitry sites, flexibly associating the distributed processor circuitry sites with the plural anchor processor circuitry servers whereby an initial anchor processor circuitry server involved in initial setup of the connection maintains the context for the connection regardless to which distributed processor circuitry site the connection is handed over.

19. The method of claim 11, further comprising:
multiplexing through the tunnel radio bearers for plural connections between the anchor processor circuitry and respective plural wireless terminals, and identifying each connection by a header that includes both a wireless terminal identifier and a session identifier.

20. The method of claim 11, wherein the radio access network is a fifth generation radio access network that connects over a NG interface to a core network.
